(19) United States
(12) Patent Application Publication
(10) Pub. No.: US 2019/0042055 A1
(43) Pub. Date: Feb. 7, 2019

(54) TOUCH DISPLAY DRIVING CIRCUIT

(71) Applicant: SITRONIX TECHNOLOGY CORP., Jhubei City (TW)

(72) Inventors: YAO-SHENG HU, JHUBEI CITY (TW); CHING-JEN TUNG, JHUBEI CITY (TW); CHUN-KUAN WU, JHUBEI CITY (TW)

(21) Appl. No.: 16/056,742

(22) Filed: Aug. 7, 2018

Related U.S. Application Data
(60) Provisional application No. 62/541,890, filed on Aug. 7, 2017.

(51) Int. Cl. G06F 3/041; G06F 3/044

(52) U.S. Cl. CPC G06F 3/0418; G06F 2203/04107; G06F 3/044; G06F 3/0412

(57) ABSTRACT

The present invention provides a touch display driving circuit, which comprises a source driving circuit and a touch detection circuit. The source driving circuit is coupled to a plurality of source lines of a touch display panel. The touch display driving circuit outputs a touch driving signal to one of the plurality of source lines during a touch detection cycle. The touch detection circuit receives a plurality of touch sensing signals via the corresponding common electrode of the source line. The plurality of touch sensing signals are then generated according to the touch driving signal.

### FIELD OF THE INVENTION

The present invention relates generally to a driving circuit, and particularly to a touch display driving circuit for reducing the influence of parasitic capacitance.

### BACKGROUND OF THE INVENTION

With the prevalence of touch display devices, various types of touch display devices are developed for different requirements. For example, the in-cell and out-cell technologies improve touch display devices in different aspects for satisfying the demands in thinness for mobile devices. The so-called in-cell touch display devices are designs embedded and highly integrated into liquid crystal displays (LCD), categorized into single-sided and double-sided designs. In single-sided touch sensors, Tx electrodes/Rx electrodes are integrated on the same layer, for example, the sensing layer, which is coated below the color filter. On the others hand, double-sided touch sensors dispose Tx electrodes/Rx electrodes on and below the liquid crystal layer structure, respectively. Thereby, in terms of fabrication processes, since the design for the structure of single-sided touch sensors is simpler than double-sided ones, the process steps can be further simplified.

Unfortunately, for the single- or double-sided in-cell design of touch sensors, high integration is required in the panel process. In addition, it should be taken into account that the extracted signal quality of touch signals might be influenced by display signals. Moreover, the influence of the parasitic capacitance of liquid crystal display panels on the touch detection sensitivity should be considered as well. Consequently, the design challenges for in-cell touch display devices are increased. Currently, the related technologies for improving touch signal interference include the U.S. Pat. No. 9,164,641B1 and the PROC Patent Publication Numbers CN102929460B and CN202887154U. Normally, outside of the touch display driving circuit, a guard circuit and coupling capacitors and their circuits are disposed for generating and transmitting active guard signals and improving the parasitic capacitance effect. Nonetheless, this solution will increase the manufacturing costs of touch display devices. Besides, the touch driving signal TX is generally generated by the additionally disposed coupling capacitors and transmitted to the common electrode COM, further increasing the manufacturing costs.

Accordingly, the present invention provides a touch display driving circuit for improving the influence of parasitic capacitance on the touch detection sensitivity as well as lowering the manufacturing costs of touch display devices.

### SUMMARY

An objective of the present invention is to provide a touch display driving circuit for improving the influence of parasitic capacitance on the touch detection sensitivity.

The present invention discloses a touch display driving circuit, which comprises a source driving circuit and a touch detection circuit. The source driving circuit is coupled to a plurality of source lines of a touch display panel. The touch display driving circuit outputs a touch driving signal to one of the plurality of source lines during a touch detection cycle. The touch detection circuit receives a plurality of touch sensing signals via the corresponding common electrode of the source line. The plurality of touch sensing signals are then generated according to the touch driving signal.

The touch display driving circuit outputs source active guard signals to the others source lines of the plurality of source lines. Alternatively, the output terminals of the source driving circuit are in a floating state to make the others source lines of the plurality of source lines to the floating state.

The output terminals of the source driving circuit coupled to the others source lines of the plurality of source lines output a plurality of source active guard signals or are in the floating state, respectively. A plurality of output terminals of a gate driving circuit output a plurality of gate active guard signals or are in the floating state, respectively.

Moreover, the touch display driving circuit comprises a gate driving circuit coupled to a plurality of scan lines of the touch display panel. In the touch detection cycle, the gate driving circuit outputs the gate active guard signals to the plurality of scan lines. Alternatively, the gate driving circuit is coupled to the plurality of scan lines of the touch display panel. During the touch detection cycle, the plurality of output terminals of the gate driving circuit are floating and hence making the plurality of scan lines floating as well.

### BRIEF DESCRIPTION OF THE DRAWINGS

FIG. 1 shows a schematic diagram of the touch display driving circuit according to a first embodiment of the present invention;

FIG. 2 shows a schematic diagram for detecting touch sensing signal according to an embodiment;

FIG. 3 shows a schematic diagram of the touch display driving circuit according to a second embodiment of the present invention; and

FIG. 4 shows a schematic diagram of the touch display driving circuit according to a third embodiment of the present invention.

### DETAILED DESCRIPTION

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

In order to make the structure and characteristics as well as the effectiveness of the present invention to be further understood and recognized, the detailed description of the present invention is provided as follows along with embodiments and accompanying figures.

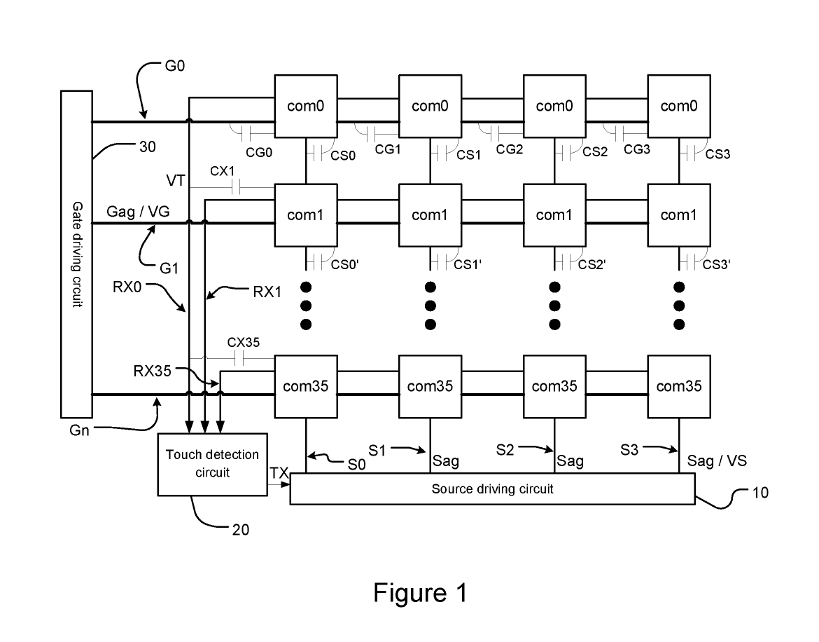

Please refer to FIG. 1, which shows a schematic diagram of the touch display driving circuit according to a first embodiment of the present invention. As shown in the figure, the touch display driving circuit comprises a source driving circuit 10 and a touch detection circuit 20. The source driving circuit 10 is coupled to a plurality of source lines S0, S1, S2, S3 of a touch display panel. The plurality of source lines S0, S1, S2, S3 are coupled to a plurality of pixel electrodes of the touch display panel. According to FIG. 1, the plurality of pixel electrodes are located below a plurality of common electrodes com0˜com35 and not illustrated. Nonetheless, FIG. 1 is only used for illustrating the technical content, not for limiting the location of the pixel electrodes and the common electrodes. In addition, the source driving circuit 10 is generally coupled to more source lines. However, for brevity, only the source lines S0, S1, S2, S3 are described in the present embodiment and illustrated in the figures. The number of the source lines coupled to the source driving circuit 10 is not limited to four. The plurality of source lines S0˜S3 are coupled to the plurality of common electrodes com0˜com35 through the parasitic capacitances CS0, CS1, CS2, CS3. To elaborate, the parasitic capacitance CS0 exists between the common electrode com0 and the source line S0 coupled by the pixel electrode corresponding to the common electrode com0 owing to the parasitic effect. For the same source line S0, another parasitic capacitance CS0′ exists between another common electrode com1 and the source line S0 owing to the parasitic effect. Besides, for another source line S1, the parasitic capacitance CS1 exists between the common electrode com0 and the source line S1 coupled by the pixel electrode corresponding to the common electrode com0 owing to the parasitic effect. The parasitic capacitances between the rest common electrodes and the source lines exist according to the same principle. Hence, the details will not be described further.

In a frame display cycle, the source driving circuit 10 outputs a plurality of source signals VS to the plurality of source lines S0˜S3 for driving the plurality of pixel electrodes and enabling the touch display panel to display a frame. In a touch detection cycle, the source driving circuit 10 outputs the touch driving signal TX to one of the plurality of source lines S0˜S3. For example, the source line S0 in FIG. 1. By means of the coupling effect of the parasitic capacitances CS0, CS0′, . . . , the touch driving signal TX on the source line S0 can be coupled to the common electrodes com0˜com35. Thereby, the touch detection circuit 20 detects the touch sensing signals VT on the plurality of common electrodes com0˜com35, respectively, via a plurality of touch detection lines RX0˜RX35. The plurality of touch sensing signals VT are generated according to the touch driving signals TX. For example, when a touch object, such as a finger or a stylus, does not touch a touch display panel, the plurality of touch sensing signals VT are in a first level. As the touch object touches the touch display panel, the touch sensing signals VT are in a second level, which is lower than the first level. Thereby, the touch sensing signals VT can be used for judging if the common electrodes com0˜com35 are touched by the touch object.

According to the present embodiment, the touch detection circuit 20 can be coupled to the source driving circuit 10 for outputting the touch driving signals TX to the plurality of source lines S0˜S3 via the source driving circuit 10. Nonetheless, according to another embodiment of the present invention, the touch detection circuit 20 can be coupled to the plurality of source lines S0˜S3 for outputting the touch driving signals TX to the plurality of source lines S0˜S3 directly. Besides, according to another embodiment of the present invention, touch detection and the display driving circuit can be integrated for using the source driving circuit 10 to generate the touch driving signals TX and output the touch driving signals TX to the plurality of source lines S0˜S3.

Furthermore, the plurality of source lines S0˜S3 can be adjacent or not adjacent, such as having a specific spacing, source lines on the display panel. In addition, according to some embodiments of the present invention, the touch driving signals TX can be output to a plurality of source lines concurrently. For example, because the distances between the source lines for transmitting the source signals VS of different colors including red, green, and blue on the same row of pixels are very close, the touch driving signals TX can be output to the source lines for different colors on the same row of pixels concurrently.

According to the present invention, the original source line S0 is used for transmitting the touch driving signal TX. The parasitic capacitances CS0, CS0′, . . . between the source line S0 and the common electrodes com0˜com35 are used for coupling the touch driving signal TX to the common electrode com0˜com35. Thereby, compared to the prior art, in which additionally disposed coupling capacitors are required for transmitting the touch driving signal TX to the common electrode COM, the circuit and capacitors required for transmitting the touch driving signal TX can be omitted according to the embodiments of the present invention and thus saving the costs of touch display devices.

Furthermore, according to the prior art, various parasitic capacitances of display panels, including the parasitic capacitance between source lines and the common electrode, should be minimized. Alternatively, active guard signals can be applied to the others terminals of parasitic capacitances to improve the parasitic capacitance effect and hence reducing the influence of parasitic capacitances on the touch detection sensitivity. According to the embodiments of the present invention, because the touch driving signal TX can be coupled to the common electrodes directly through the parasitic capacitances between the source lines and the common electrodes, signal transmission is done via the parasitic capacitances between the source lines and the common electrodes. Hence, the parasitic capacitances will not influence the touch detection sensitivity.

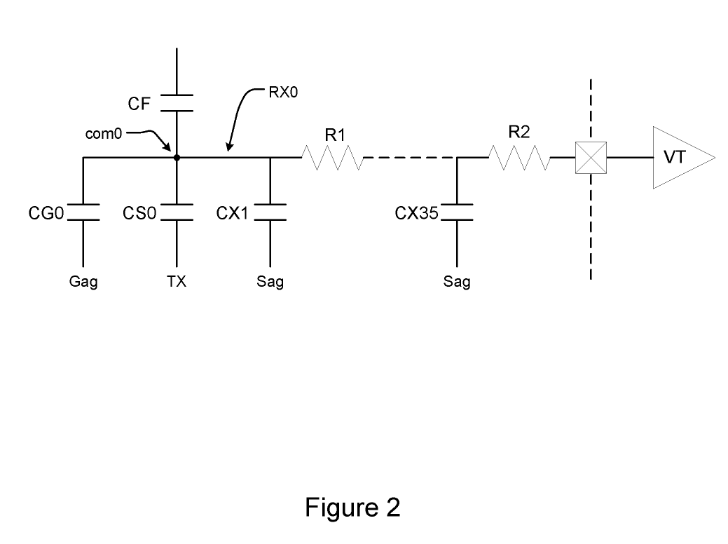

Please refer again to FIG. 1. The touch display driving circuit can further comprise a gate driving circuit 30 coupled to a plurality of scan lines G0, G1, . . . , Gn coupled to the touch display panel. In the frame display cycle, the gate driving circuit 30 outputs a plurality of gate signals VG to the plurality of scan lines G0, G1, . . . , Gn for scanning the touch display panel. According to the embodiment of FIG. 1 and taking a common electrode com0 on one source line S0 for example, the equivalent circuit can be illustrated as FIG. 2. Owing to the parasitic capacitance effect, parasitic capacitances exist between the common electrode com0 and the plurality of scan lines. For example, a relatively larger parasitic capacitance CG0 exists between the common electrode com0 and the adjacent scan line G0, compared to the one between the common electrode com0 and the others scan lines. In the touch detection cycle, to avoid the influence of the parasitic capacitance CG0 on the touch detection sensitivity, gate active guard signals Gag can be output to the plurality of scan lines G0, G1, . . . , Gn. The gate active guard signals Gag can be in phase with the touch driving signal TX and have identical voltage levels. For example, the gate active guard signals Gag and the touch driving signal TX can both be sine or square waves.

Thereby, according to the present embodiment, the gate driving circuit 30 outputs the gate active guard signal Gag to one terminal of the parasitic capacitance CG0 while the other terminal of the parasitic capacitance CG0 is connected to the common electrode com0 and receives the touch driving signal TX. Because the touch driving signal TX and the gate active guard signal Gag can be in phase and have identical voltage levels, the parasitic capacitance CG0 can be ignored.

Moreover, when the touch detection line RX0 is used to detect the touch sensing signal VT of the common electrode com0, there exist parasitic capacitances CX1˜CX35 between the touch detection line RX0 and the others common electrodes com1˜com35. In addition, the plurality of parasitic capacitances CX1˜CX35 will be coupled to the others source lines S1, S2, S3 through the parasitic effect inside the display panel. Thereby, to avoid the influence of the plurality of parasitic capacitance CX1˜CX35 on the touch detection sensitivity, source active guard signals Sag can be output to the plurality of source lines S1, S2, S3 not used for the touch detection. In other words, the source driving circuit 10 outputs the touch driving signal TX to one of plurality of source lines S0, S1, S2, S3 and outputs the source active guard signal Sag to the others source lines S1, S2, S3, except the source line S0 receiving the touch driving signal TX, for reducing the influence of the parasitic capacitances of the touch display panel on the touch detection sensitivity. Besides, the source active guard signals Sag can be in phase with the touch driving signal TX and have identical voltage levels. For example, the source active guard signals Sag and the touch driving signal TX can both be sine or square waves.

Thereby, according to the present embodiment, the source driving circuit 10 outputs the plurality of source active guard signals Sag to one terminal of each of the plurality of parasitic capacitances CX1˜CX35 while the others terminal of each of the plurality of parasitic capacitances CX1˜CX35 is connected to the common electrode com0 and receives the touch driving signal TX. Because the touch driving signal TX and the plurality of source active guard signals Sag can be in phase and have identical voltage levels, the parasitic capacitances CX1˜CX35 can be ignored. In other words, after a finger touches the touch display panel, the variation of the touch sensing signal VT is only influenced by the ratio of the parasitic capacitance CS0 between the source line S0 and the common electrode com0 to the finger capacitance CF. Hence, higher touch detection sensitivity can be maintained.

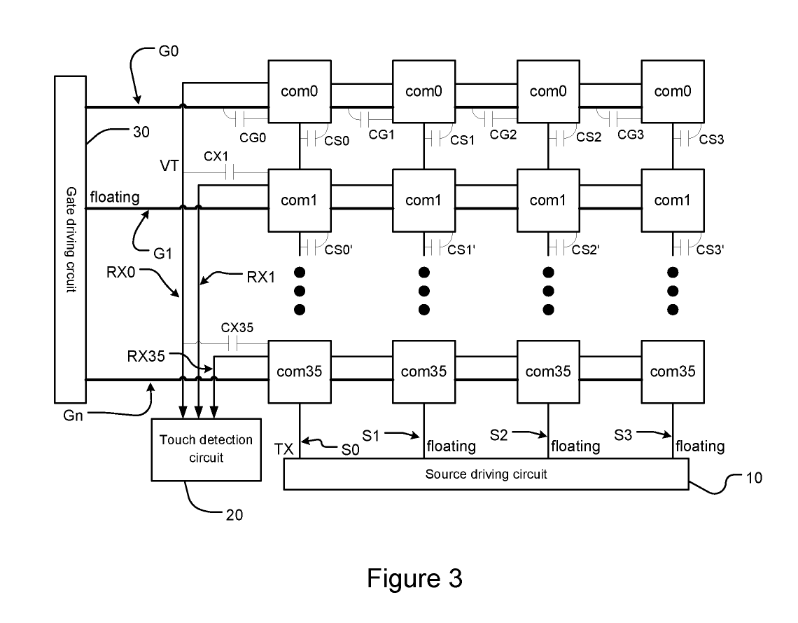

There are different embodiments for the touch display driving circuit to drive the plurality of source lines S0˜S3 and the plurality of scan lines G0˜Gn to reduce the influence of the parasitic capacitances of the touch display panel on the touch detection sensitivity. Please refer to FIG. 3, which shows a schematic diagram of the touch display driving circuit according to a second embodiment of the present invention. As shown in the figure, during the touch detection cycle, the touch display driving circuit outputs the touch driving signal TX to one of the plurality of source lines, namely, the source line S0. The others source lines S1˜S3 and the plurality of scan lines G0˜Gn are kept in a floating state. In other words, one of a plurality of outputs of the source driving circuit 10 outputs the touch driving signal TX to the source line S0. The others outputs of the plurality of outputs of the source driving circuit 10 can be in the floating state and thus making the others source lines S1˜S3 in the floating state as well. Likewise, a plurality of outputs of the gate driving circuit 30 can be in the floating state and thus making the plurality of scan lines G0˜Gn in the floating state.

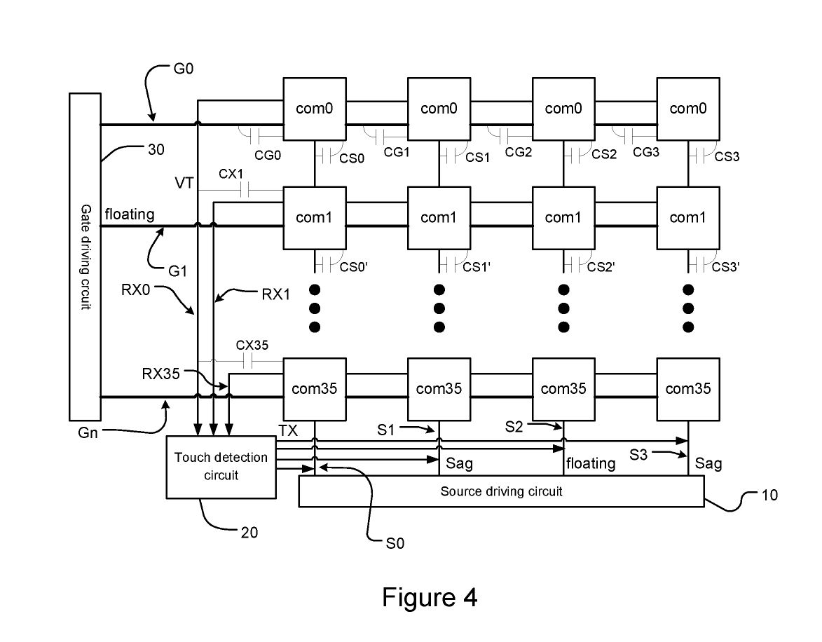

Please refer to FIG. 4, which shows a schematic diagram of the touch display driving circuit according to a third embodiment of the present invention. As shown in the figure, the plurality of outputs of the gate driving circuit 30 can output the gate active guard signals Gag or be floating. Except the source line S0 performing touch detection and transmitting the touch driving signal TX, the rest source lines S1, S2, S3 can transmit the source active guard signals Sag or be floating. In addition, according to the embodiment of FIG. 1 to FIG. 3, the source driving circuit 10, the touch detection circuit 20, and the gate driving circuit 30 can be integrated to form a touch display driving chip.

To sum up, the present invention discloses a touch display driving circuit, which comprises a source driving circuit and a touch detection circuit. The source driving circuit is coupled to a plurality of source lines of a touch display panel. The touch display driving circuit outputs a touch driving signal to one of the plurality of source lines during a touch detection cycle. The touch detection circuit receives a plurality of touch sensing signals via the corresponding common electrode of the source line. The plurality of touch sensing signals are then generated according to the touch driving signal.

The touch display driving circuit outputs source active guard signals to the others source lines of the plurality of source lines. Alternatively, the output terminals of the source driving circuit are in a floating state to make the others source lines of the plurality of source lines to the floating state.

The output terminals of the source driving circuit coupled to the others source lines of the plurality of source lines output a plurality of source active guard signals or are in the floating state, respectively. A plurality of output terminals of a gate driving circuit output a plurality of gate active guard signals or are in the floating state, respectively.

Moreover, the touch display driving circuit comprises a gate driving circuit coupled to a plurality of scan lines of the touch display panel. In the touch detection cycle, the gate driving circuit outputs the gate active guard signals to the plurality of scan lines. Alternatively, the gate driving circuit is coupled to the plurality of scan lines of the touch display panel. During the touch detection cycle, the plurality of output terminals of the gate driving circuit are floating and hence making the plurality of scan lines floating as well.

What is claimed is:

1. A touch display driving circuit, comprising:
a source driving circuit, coupled to a plurality of source lines of a touch display panel, said touch display driving circuit outputting a touch driving signal to one of said plurality of source lines in a touch detection cycle; and
a touch detection circuit, receiving a plurality of touch sensing signals via the corresponding common electrode of said source line, and said plurality of touch sensing signals being generated according to said touch driving signal.

2. The touch display driving circuit of claim 1, wherein said touch display driving circuit outputs a source active guard signal to the others source lines of said plurality of source lines.

3. The touch display driving circuit of claim 2, wherein said source active guard signal is in phase with said touch driving signal.

4. The touch display driving circuit of claim 1, wherein the output terminals of the source driving circuit coupled to the others source lines of the plurality of source lines are floating and hence making the others source lines of said plurality of source lines floating.

5. The touch display driving circuit of claim 1, and comprising a gate driving circuit, coupled to a plurality of scan lines of a touch display panel, and outputting a gate active guard signal to said plurality of scan lines in said touch detection cycle.

6. The touch display driving circuit of claim 5, wherein said gate active guard signal is in phase with said touch driving signal.

7. The touch display driving circuit of claim 1, and further comprising a gate driving circuit, coupled to a plurality of scan lines of a touch display panel, having a plurality of outputs floating in said touch detection cycle, and hence making said plurality of scan lines floating.

8. The touch display driving circuit of claim 1, wherein the output terminals of the source driving circuit coupled to the others source lines of the plurality of source lines output a plurality of source active guard signals or are floating, respectively, and a plurality of outputs of said gate driving circuit output a plurality of gate active guard signals or are floating, respectively.

9. The touch display driving circuit of claim 1, wherein a gate driving circuit and said source driving circuit are coupled to a plurality of scan lines and a plurality of source lines of a touch display panel, respectively; said gate driving circuit outputs a plurality of scan signals to said plurality of scan lines in a frame display cycle; and said source driving circuit outputs a plurality of source signals to said plurality of source lines in said frame display cycle.

10. The touch display driving circuit of claim 1, wherein when a touch object does not touch a touch display panel, said touch sensing signal is at a first level; when said touch object touches said touch display panel, said touch sensing signal is at a second level; and said second level is lower than said first level.

11. The touch display driving circuit of claim 1, wherein said source driving circuit of said touch display driving circuit outputs said touch driving signal to one of said plurality of source lines in said touch detection cycle.

12. The touch display driving circuit of claim 1, wherein said touch detection circuit of said touch display driving circuit is coupled to said plurality of source lines, said touch detection circuit outputs said touch driving signal to one of said plurality of source lines in said touch detection cycle.

13. The touch display driving circuit of claim 1, wherein said touch detection circuit of said touch display driving circuit is coupled to said source driving circuit, said touch detection circuit outputs said touch driving signal to one of said plurality of source lines via said source driving circuit in said touch detection cycle.
